(19) United States
(12) Patent Application Publication
(10) Pub. No.: US 2004/0115472 A1
(43) Pub. Date: Jun. 17, 2004

(54) Method of forming a diffusion barrier on a metallic substrate

(75) Inventors: Mark H. Shipton, Bristol (GB); Terence W. Maber, Bristol (GB); Martin J. Deakin, Ashby de la Zouch (GB)

Correspondence Address: OLIFF & BERRIDGE, PLC, P.O. BOX 19928, ALEXANDRIA, VA, 22320, US

(73) Assignee: ROLLS ROYCE PLC., London (GB)

(21) Appl. No.: 10/676,042

(22) Filed: Oct. 2, 2003

(30) Foreign Application Priority Data
Oct. 21, 2002 (GB) 0224301.2

(51) Int. Cl. B32B 15/01

(52) U.S. Cl. 428/660; 428/670; 428/651

(57) ABSTRACT

A method of forming a platinum aluminide diffusion barrier on a metallic substrate, eg a titanium alloy aerospace component, comprises applying to the metallic substrate a coating comprising particulate platinum and particulate aluminium in an organic carrier and performing a reaction treatment on the thus applied platinum and aluminium which causes the platinum and the aluminium to form an intermetallic diffusion barrier on the metallic substrate.

The present invention relates to a method of forming a platinum aluminide diffusion barrier on a metallic substrate, and an oxidation resistant metallic structure formed thereby. In one particularly preferred form of the invention, the metallic substrate is a titanium alloy, and the platinum aluminide diffusion barrier serves to protect the alloy against the damaging effects of α-case oxide formation in high temperature oxidative environments.

It is known to use a platinum aluminide intermetallic surface diffusion barrier to improve the oxidation and corrosion resistance of a metallic substrate without substantial detriment to the mechanical properties of the substrate, particularly in conditions of high temperature (eg above about 650° C.).

WO-A-94/18359, the disclosure of which is incorporated herein by reference, discloses the formation of a platinum aluminide layer on a titanium substrate by sequential deposition of a platinum layer followed by an aluminium layer. This two-layer deposited system is then subjected to a reaction treatment consisting of heating the deposited materials under moderate vacuum for a period of two hours at a temperature of 750° C., causing the formation of a platinum aluminide diffusion barrier. Deposition of the layers is stated to be by RF biased DC sputtering.

The sputtering technique suffers from the disadvantage that it is not usable where the substrate is a large metallic component. There remains a need for a method of forming a diffusion barrier on a metallic substrate which is generally applicable to articles of any size within a large range of sizes, from the order of millimetres to the order of metres.

The present invention is based on our surprising finding that a platinum aluminide diffusion barrier can conveniently be formed on a metallic substrate by applying the platinum and aluminium metallic starting materials entrained in an organic carrier. This method has the advantages that it is quicker, less costly and may be applied to a much wider range of substrate sizes than the prior art methods. Additionally since the coating can be formed at a lower temperature than with conventional methods it is less likely the component will be distorted during the coating process. The lower temperature required for coating components according to the present invention also results in uncoated regions of the component being oxidised to a lesser degree than if the component is raised to a higher temperature, thus retaining the integrity of the component and reducing the formation of the α-case oxide.

According to a first aspect of the present invention, there is provided a method of forming a platinum aluminide diffusion barrier on a metallic substrate which comprises a titanium alloy, the method comprising the steps of:

a) applying to the metallic substrate a coating comprising particulate platinum and particulate aluminium in an organic carrier;

b) performing a reaction treatment on the thus applied platinum and aluminium which comprises subjecting the platinum particles and the aluminium particles to a temperature in the range of about 200° C. to about 600° C. for a time sufficient for the reaction between the platinum and the aluminium to form a diffusion barrier on the metallic substrate.

By the term “diffusion barrier”, we mean a material overlying a surface of the metallic substrate, the material having a sufficiently low permeability to oxygen under the intended conditions of use of the substrate that oxygen is substantially prevented from contacting the metallic substrate from the surrounding atmosphere.

The coating may be applied to the metallic substrate in one or more application steps. If more than one application step is used, the components of the coating may be built up in the successive steps, eg by applying different materials in each step. It is preferred that the platinum and aluminium particles are applied as particles entrained in the organic carrier. A single composition entraining both metals in a desired molar ratio may be used, or separate compositions (eg each entraining one of the metals in a known concentration).

The metallic substrate preferably comprises an aerospace component or a portion thereof, eg a titanium alloy aerospace component or portion thereof.

According to a second aspect of the present invention, there is provided an oxidation resistant structure comprising a metallic substrate (eg a titanium alloy aerospace component or portion thereof and a platinum aluminide diffusion barrier disposed thereon, wherein the structure is formed by the method according to the first aspect of the present invention.

According to a third aspect of the present invention, there is provided an oxidation resistant aerospace component comprising a metallic substrate comprising a titanium alloy and a substantially uniform platinum aluminide diffusion barrier disposed thereon, said diffusion barrier being formed by the method according to the first aspect of the present invention.

Preferably the continuous area of the diffusion barrier is at least about 200 cm², more particularly at least about 400 cm², for example at least about 600 cm².

The aerospace component according to the third aspect of the present invention is formable by the method of the first aspect, and is preferably formed using that method.

Preferably, the oxidation resistant structure or component exhibits substantially no diffusion of constituents of the diffusion barrier into the metallic substrate and substantially no detrimental reaction between constituents of the diffusion barrier and the metallic substrate.

The Metallic Substrate

The metallic substrate may comprise any metal or metal alloy and is suitably of relatively low density, for example less than about 7 gcm⁻³, less than about 6 gcm⁻³ or less than about 5 gcm⁻³. The metallic substrate suitably has a relatively high melting point or melting range. For example, the melting point or midpoint of the melting range may suitably be above about 100° C., for example above about 1300° C., more preferably above about 1400° C., and most preferably above about 1500° C.

The metal substrate may comprise a first metal as the main component and any other suitable metal or metals as a further component or components. It will be appreciated that the metallic substrate may also comprise semi- and non-metallic components in addition to metallic components. These semi- and non-metallic components may typically be present in lower amounts than the main metallic component, for example less than about 5% by weight, less than about 3% by weight or less than about 1% by weight.

The main component of the metallic substrate preferably comprises a transition metal or a transition metal alloy. The metallic substrate preferably comprises titanium, an alloy of titanium, steel or stainless steel. In a preferred embodiment, the metallic substrate comprises a titanium alloy substantially in the beta form.

In the case where the metal substrate is a titanium alloy, it will comprise titanium as the main component and preferably one or more subsidiary components selected from the group consisting of aluminium, beryllium, bismuth, chromium, cobalt, gallium, hafnium, iron, manganese, molybdenum, niobium, nickel, oxygen, rhenium, tantalum, tin, tungsten, vanadium and zirconium. This alloy may also suitably comprise one or more semi- or non-metallic elements selected from the group consisting of boron, carbon, silicon, phosphorous, arsenic, selenium, antimony and tellurium. These elements may serve to increase the oxidation, creep or burning resistance of the metallic substrate.

Titanium may be present in such a titanium alloy in an amount greater than about 40% by weight, for example greater than about 50% by weight, greater than about 60% by weight or greater than about 70% by weight and in some embodiments may be present in an amount greater than about 80% by weight.

The amount in which the subsidiary component or components are present is determined by the use to which the metallic substrate will be put, as will be well understood by those skilled in this art. For example, the metallic substrate may be a ternary alloy comprising titanium, vanadium and chromium. Certain compositions of this type are especially preferred for certain applications wherein the titanium is present substantially in the beta form under most temperature conditions i.e. has less than about 3 wt % alpha phase titanium, preferably less than about 2 wt % alpha phase titanium. Such beta titanium alloys are based on ternary compositions of titanium-vanadium-chromium which occur in the titanium-vanadium-chromium phase diagram bounded by the points Ti-22V-13Cr, Ti-22V-36Cr, and Ti-40V-13Cr. These compositions are known to have useful mechanical properties such as high creep strength and a lack of combustibility at temperatures of up to at least about 650° C. In such compositions, the titanium is preferably present in an amount greater than about 40% by weight, for example greater than about 50% by weight. The chromium is preferably present in an amount greater than about 10% by weight, for example greater than about 15% by weight or greater than about 25% by weight. This concentration of chromium is necessary to provide the required non-burning characteristics of the alloy at these high temperatures. Vanadium may be present in an amount greater than about 20% by weight, for example greater than 25% by weight or greater than about 30% by weight. A specific alloy of this type has a composition comprising about 50 wt % titanium, about 35 wt % vanadium and about 15 wt % chromium.

In other applications, the elements of the alloy composition will be significantly different. For example, the metallic substrate may comprise a quaternary or higher order alloy comprising titanium and other metals or semi-metals selected from the group consisting of aluminium, chromium, copper, iron, molybdenum, niobium, silicon, tin, vanadium and zirconium. In such alloys, aluminium is preferably present in an amount less than 10 wt %, for example less than 8 wt %; chromium is preferably present in an amount less than 10 wt %, for example less than 8 wt %; copper is preferably present in an amount less than 5 wt %, for example less than 3 wt %; iron is preferably present in an amount less than 5 wt %, for example less than 3 wt %; molybdenum is preferably present in an amount less than 10 wwt %, for example less than 8 wt %; niobium is preferably present in an amount less than 6 wwt %, for example less than 4 wt %; silicon is preferably present in an amount less than 2 wwt %, for example less than 1 wt %; tin is preferably present in an amount less than 16 wt %, for example less than 12 wt %; vanadium is preferably present in an amount less than 15 wt %, for example less than 10 wt %; and zirconium is preferably present in an amount less than 8 wt %, for example less than 6 wt %.

Titanium alloys are known to be generally susceptible to oxidation damage through the formation of the so-called α-case oxide layer. The diffusion barrier established according to the present invention is found to substantially restrict such oxidation damage in titanium alloys.

The Aerospace Component

Where the metallic substrate comprises an aerospace component or portion thereof, the component is preferably a component of an aero-engine which in use may be exposed to conditions of relatively high temperature (eg above about 400° C., particularly above about 650° C.), eg casings, compressor drums, vanes, discs, blades, shafts, plugs or nozzles.

The Organic Carrier

The organic carrier provides a medium entraining the platinum or aluminium metal particles, enabling the particles to be applied in a generally uniform manner to the substrate surface.

The organic carrier preferably comprises relatively volatile components and relatively non-volatile components. The relatively volatile (fugitive) components serve to establish the desired physical properties of the carrier during the stage of application to the metallic substrate, and will subsequently evaporate off to leave a dry residue of the relatively non-volatile (binder) components, which will serve to bind the platinum and aluminium particles in intimate admixture on the surface of the metallic substrate for the reaction stage to form the intermetallic diffusion barrier.

The organic carrier is preferably liquid at room temperature. Its physico-chemical properties will be selected according to the specific conditions of use, as will be well understood by those of skill in this art.

For example, in addition to an appropriate balance of fugitive and binder components, the carrier may conveniently have a rheology (ie viscosity and thixotropy) providing good nozzle-non-blocking sprayability or good brush-, blade- or roller-spreadability onto the metallic substrate, resulting in good, uniform application to the substrate surface. The viscosity of the liquid carrier may be selected to restrict sedimentation of entrained metallic particles prior to use.

The surface tension of the organic carrier may, if desired, be adjusted by means of surfactants or tensides, to optimise the application performance of the carrier and the uniformity of the applied coating prior to reaction treatment to form the intermetallic diffusion barrier. Such adjustments will be well within the capability of those skilled in this art.

The organic carrier may be a single phase composition or a multiphase composition such as an emulsion. The carrier may optionally include water, for example 0 to about 30 wt %, preferably 0 to about 20 wt %, of the organic carrier may be water. The composition comprising the carrier and the aluminium and platinum particles is suitably a dispersion or a colloidal suspension in the sense that the aluminium and platinum particles are dispersed throughout the solution.

The organic carrier preferably comprises one or more component selected from: esters, glycols, glycol ethers, polyhydric alcohols, polymeric alcohols, polymeric resins, aromatic hydrocarbons and esters or polymers of acrylic acid or methacrylic acid. Examples of suitable organic carrier materials include an alkoxy alkanol alkanoate in which each alkyl portion may independently have up to about 5 carbon atoms, such as 1-methoxy-2-propanol acetate; an alkylene glycol monoalkyl ether alkanoate in which each alkyl portion may independently have up to about 5 carbon atoms, such as ethylene glycol monobutyl ether acetate; an alkyl alkanoate in which each alkyl portion may independently have up to about 5 carbon atoms, such as butyl acetate; a polymeric resin such as an acrylic resin; an alkyl (meth) acrylate in which the alkyl portion may have up to about 5 carbon atoms, such as methyl methacrylate; an alkyl-substituted aromatic compound in which the alkyl portion may have up to about 5 carbon atoms, such as toluene; and any mixture thereof.

The major component of the organic carrier is preferably one or more organic esters. The ester component may suitably comprise up to about 70% by weight of the carrier, eg about 20 to about 65% by weight. The polymeric resin is preferably present in an amount of between about 1 and about 20% by weight. The remaining components, if present, are preferably present in relatively small individual amounts, eg between about 0.01 and about 5% by weight for each component.

In a preferred embodiment, the carrier consists essentially of:

1 methoxy-2-propanol acetate (preferably 10-30 wt %)

ethylene glycol monobutyl ether acetate (preferably 10-30 wt %)

butyl acetate (preferably 10-30 wt %)

acrylic resin (preferably 5-10 wt %)

methyl methacrylate (preferably less than 0.1 wt %)

toluene (preferably less than 0.1 wt %).

The carrier medium may entrain: (i) platinum particles with aluminium particles in any desired molar ratio; (ii) platinum particles without aluminium particles, at any desired concentration of platinum; (iii) or aluminium particles without platinum particles, at any desired concentration of aluminium. Further details of the different modes of application of the different compositions are given below.

The calculation of the appropriate concentration of platinum and aluminium particles in the carrier medium will be well within the capability of those skilled in this art, having regard to the desired molar ratio of the particles in the dry residue of the coating for the reaction treatment. The platinum and the aluminium particles preferably comprise about 40 to about 60% of the total weight of the respective composition in which they are present.

The Particulate Platinum and Aluminium

It is preferred that the platinum and aluminium particles not so large that they sediment easily on standing in the carrier medium or that formation of a good-quality intermetallic diffusion layer is hindered. The platinum and aluminium particles may preferably be substantially uniform and similar in size. The particles may typically have an average effective diameter greater than about 1 μm, for example greater than 2 μm. Normally, the average particle size will be less than 201 μm, for example less than 10 μm, eg about 5 μm. In the case of non-spherical particles, effective diameter is expressed as the “equivalent spherical diameter” of the particle, as will be well understood by those skilled in this art. Particle size may be measured by any technique commonly used in the art, for example dynamic light scattering or transmission electron microscopy.

Preparation of the Composition(s) for Application to the Metallic Substrate

The composition(s) comprising the organic carrier and the particulate platinum and/or aluminium are prepared by conventional mixing techniques, as will be well understood by those skilled in this art.

Application of the Composition(s) to the Metallic Substrate

The composition or compositions may be applied to the metallic substrate using any convenient application technique. Typically, spraying, brushing, blade-spreading or roller spreading may be used. In a particularly preferred embodiment, the composition(s) may be applied using a conventional aerosol spraying device comprising a nozzle through which the composition is delivered under pressure, whereby the composition forms an aerosol of fine dispersed droplets in the air.

The coating may be applied in one or more application steps. When more than one successive application step is used, the coating will preferably be built up in the successive steps, each step comprising application of a layer (preferably substantially uniform in thickness and continuous) constituting a portion of the coating.

It is preferred that the coating is applied as two layers; one layer comprising particulate platinum in a first organic carrier and the other comprising particulate aluminium in a second organic carrier. The first organic carrier may be the same or different from the second organic carrier. It is preferred that the layer comprising the aluminium particles is applied over the layer comprising the platinum particles. This is partly to facilitate the formation of an additional protective layer of aluminium oxide on treatment of the coating and partly to avoid the possibility of elemental aluminium—which has a higher diffusivity in most metals than elemental platinum—diffusing into the metallic substrate.

Formation of the Intermetallic Diffusion Barrier

Following application of the coating to the metallic substrate, the coating may suitably be allowed to dry by evaporation of some or all of the components of the organic carrier, to leave on the surface of the metallic substrate a layer of metallic platinum and aluminium particles in intimately admixture in a desired molar ratio (eg about 1:2 Pt:Al). The dry residue from the organic carrier is preferably present at this stage, serving to anchor the metal particles in position for the subsequent reaction treatment to form the intermetallic diffusion barrier.

The deposited layer is then subjected to a reaction treatment which causes the platinum and the aluminium particles to form a platinum aluminide intermetallic diffusion barrier on the metallic substrate.

The reaction treatment typically includes the step of subjecting the coated metallic substrate to an elevated temperature for a time sufficient to form a platinum aluminide diffusion barrier. This temperature may be greater than about 200° C., for example greater than about 300° C. The temperature at which the reaction treatment takes place would normally be less than about 600° C., for example less than about 500° C. In an embodiment of the invention, the reaction treatment takes place at a temperature of about 400° C.

The above reaction treatment preferably takes place under a partial vacuum and/or in an inert atmosphere. By “inert atmosphere” is meant an atmosphere comprising at least about 90% inert gas or gases, eg nitrogen. Where a partial vacuum is used, the pressure may for example be less than about 10⁻⁴ Bar, preferably about 10⁻⁵ Bar. In one embodiment of the invention, sufficient atmospheric oxygen is present to form a relatively thin aluminium oxide scale on top of the platinum aluminide diffusion barrier.

The platinum aluminide diffusion barrier is preferably in the form of a surface layer overlying the metallic substrate, the layer being typically substantially homogeneous, continuous and of substantially uniform thickness. The thickness of the barrier may depend on factors such as the severity of the ambient conditions to which the protected metallic substrate will be exposed. The barrier preferably has a thickness of greater than about 1 μm, for example greater than about 3 μm, and up to about 20 μm, for example less than about 10 μm, eg an average thickness of about 5 μm.

As mentioned above, the reaction treatment to form the platinum aluminide diffusion barrier from the coating may also cause the formation of an aluminium oxide scale on the surface of the diffusion barrier. This can further shield the metallic substrate from corrosive or oxidative agents.

The diffusion barrier formed according to the present invention may be overlay-coated by one or more further protective coatings, as will be readily apparent to those skilled in this art. For example, the platinum aluminide barrier layer may be subsequently overlay-coated with an 80/20 Ni/Cr oxidation resistant layer.

### INDUSTRIAL APPLICABILITY

The present invention provides an improved or at least alternative method for protecting metallic substrates (eg titanium alloys) against oxidation damage, particularly in high temperature oxidative or corrosive environments such as aero-engines.

The diffusion barrier according to the invention is found to be substantially inert and has sufficient strength and resistance to cracking to maintain its integrity under the wear and vibration conditions typically found in aero-engines. It does not interact adversely with the metallic substrate to an appreciable extent. It is also resistant to erosion and cracking under repeated cycling from low to high temperatures.

Additionally since the coating can be formed at a lower temperature than with conventional methods it is less likely the component will be distorted during the coating process. The lower temperature required for coating components according to the present invention also results in uncoated regions of the component being oxidised to a lesser degree than if the component is raised to a higher temperature, thus retaining the integrity of the component and reducing the formation of the α-case oxide.

Since the coating may have been formed in an environment where oxygen is still present, perhaps because it was formed in a partial vacuum or in an inert atmosphere contaminated with oxygen, any regions of a substrate comprising a titanium alloy which are exposed (eg not being coated) will have a higher propensity for α-case oxide formation as the exposed substrate surface temperature is increased.

The above broadly describes the present invention without limitation. Variations and modifications as will be readily apparent to those skilled in this art are intended to be included in the scope of this application and any resultant patents.

1. A method of forming a platinum aluminide diffusion barrier on a metallic substrate which comprises a titanium alloy, the method comprising the steps of:
a) applying to the metallic substrate a coating comprising particulate platinum and particulate aluminium in an organic carrier;
b) performing a reaction treatment on the thus applied platinum and aluminium which comprises subjecting the platinum particles and the aluminium particles to a temperature in the range of about 200° C. to about 600° C. for a time sufficient for the reaction between the platinum and the aluminium to form a diffusion barrier on the metallic substrate.

2. A method according to claim 1, wherein the reaction treatment takes place in an inert atmosphere.

3. A method according to claim 1, wherein the coating is applied in more than one step, whereby the coating is built up on the metallic substrate.

4. A method according to claim 1, wherein the platinum particles and the aluminium particles are applied as the particles entrained in the organic carrier, as a single composition or sequentially as separate compositions.

5. A method according to claim 1, wherein the organic carrier comprises relatively volatile components and relatively non-volatile components, whereby the organic carrier forms a dry residue on the metallic substrate after application, anchoring the platinum particles and the aluminium particles for the reaction treatment to form the diffusion barrier.

6. A method according to claim 1, wherein the aluminium particles have an average effective diameter in the range of about 2 to about 10 μm.

7. A method according to claim 1 of the preceding claims, wherein the platinum particles have an average effective diameter in the range of about 2 to about 10 μm.

8. An oxidation resistant structure comprising a metallic substrate which comprises a titanium alloy and a platinum aluminide diffusion barrier disposed thereon, wherein the structure is formed by a method according to claim 1.

9. A structure according to claim 8, wherein the platinum aluminide diffusion barrier has a substantially uniform thickness over the major part of its area.

10. A structure according to claim 8, which comprises an aerospace component or a portion thereof.

11. A structure according to any one of claim 8, wherein the platinum aluminide diffusion barrier has a thickness in the range of about 2 to about 10 μm.

12. An oxidation resistant aerospace component comprising a metallic substrate which comprises a titanium alloy and a substantially uniform platinum aluminide diffusion barrier disposed thereon said diffusion barrier being formed by a method according to claim 1.

13. An oxidation resistant aerospace component as claimed in claim 12 wherein the diffusion barrier is continuous over an area of at least about 200 cm².

14. A component according to claim 12 wherein the platinum aluminide diffusion barrier has a thickness in the range about 2 to about 10 μm.
